(19) United States
(12) Patent Application Publication
(10) Pub. No.: US 2025/0277097 A1
(43) Pub. Date: Sep. 4, 2025

(54) DEPOLYMERIZATION REACTION MONITORING DEVICE, DEPOLYMERIZATION REACTION MONITORING METHOD, AND DEPOLYMERIZATION REACTION MONITORING PROGRAM

(71) Applicant: SUMITOMO HEAVY INDUSTRIES, LTD., Tokyo (JP)

(72) Inventors: Takashi SUZUKI, Yokosuka-shi (JP); Yoshiko SHISHIDO, Yokosuka-shi (JP); Mayuka NOMURA, Yokosuka-shi (JP); Takayuki MENJO, Yokosuka-shi (JP)

(21) Appl. No.: 19/201,959

(22) Filed: May 8, 2025

Related U.S. Application Data
(63) Continuation of application No. PCT/JP2023/038254, filed on Oct. 24, 2023.

(30) Foreign Application Priority Data
Dec. 8, 2022 (JP) 2022-196415

(51) Int. Cl. C08J 11/24; B01J 19/00; B01J 19/24

(52) U.S. Cl. CPC C08J 11/24; B01J 19/0006; B01J 19/24; B01J 2219/00213; C08J 2367/03

(57) ABSTRACT

A depolymerization reaction monitoring device includes: a depolymerization reaction tank that causes a depolymerization reaction in which a polyester is decomposed into a depolymerized product by using a depolymerization material; a characteristic measuring unit that measures a characteristic of the depolymerization material in which the depolymerized product is dissolved at the depolymerization reaction tank; and a progress monitoring unit that monitors progress of the depolymerization reaction based on the characteristic of the depolymerization material measured by the characteristic measuring unit.

### CROSS-REFERENCE TO RELATED APPLICATIONS

This is a bypass continuation of International PCT Application No. PCT/JP2023/038254, filed on Oct. 24, 2023, which claims priority to Japanese Patent Application No. 2022-196415, filed on Dec. 8, 2022, which are incorporated by reference herein in their entirety.

### BACKGROUND

### Technical Field

Certain embodiments of the present invention relate to a depolymerization reaction monitoring device and the like.

### Description of Related Art

The related art discloses a method of manufacturing polyethylene terephthalate (PET) flakes, which are raw materials for a new PET bottle, by pulverizing a PET bottle for recycling the PET bottle. Specifically, mechanical recycling for obtaining PET flakes by means of solid phase polymerization or the like after the pulverized PET bottle is heated and melted, and chemical recycling for obtaining PET flakes by means of a repolymerization reaction after the pulverized PET bottle is decomposed into an intermediate such as bis(2-hydroxyethyl) terephthalate (BHET) or a depolymerized product by a depolymerization reaction are known.

### SUMMARY

According to an embodiment of the present invention, there is provided a depolymerization reaction monitoring device including a depolymerization reaction tank that causes a depolymerization reaction in which a polyester is decomposed into a depolymerized product by using a depolymerization material, a characteristic measuring unit that measures a characteristic of the depolymerization material in which the depolymerized product is dissolved at the depolymerization reaction tank, and a progress monitoring unit that monitors progress of the depolymerization reaction based on the characteristic of the depolymerization material measured by the characteristic measuring unit.

In this embodiment, it is possible to efficiently identify the progress of the depolymerization reaction of the polyester in which the depolymerized product, which is the product, is dissolved in the depolymerization material, which is the reaction product or the catalyst, through the measurement of the characteristic of the depolymerization material in the depolymerization reaction tank.

According to an embodiment of the present invention, there is provided a depolymerization reaction monitoring method including causing a depolymerization reaction in which a polyester is decomposed into a depolymerized product by using a depolymerization material in a depolymerization reaction tank, measuring a characteristic of the depolymerization material in which the depolymerized product is dissolved at the depolymerization reaction tank, and monitoring progress of the depolymerization reaction based on the characteristic of the depolymerization material that is measured.

Any combination of the above-described components or any expression of these components converted into a method, a device, a system, a recording medium, a computer program, or the like is also included in the present invention.

### BRIEF DESCRIPTION OF THE DRAWINGS

FIG. 1 schematically shows a configuration of a chemical recycling molding system.

FIG. 2 schematically shows a polymerization reaction and a depolymerization reaction of PET.

FIG. 3 shows a modification example of a by-product removal device.

FIG. 4 shows one embodiment of a depolymerization reaction monitoring device.

FIGS. 5A and 5B show examples of monitoring progress of the depolymerization reaction by a progress monitoring unit.

FIG. 6 shows another embodiment of a depolymerization reaction monitoring device.

FIG. 7 shows an example of dilution of a depolymerization material by a depolymerization material dilution unit.

FIG. 8 is a flowchart of a specific example of a measurement procedure in another embodiment.

FIG. 9 shows still another embodiment of a depolymerization reaction monitoring device.

FIG. 10 is a flowchart of a specific example of a measurement procedure in still another embodiment.

### DETAILED DESCRIPTION

For efficient chemical recycling of PET or the like, it is important to appropriately identify progress of chemical reactions such as depolymerization reactions and repolymerization reactions. The progress of the chemical reaction can be identified by measuring a reaction product and/or a product collected from a reaction tank. However, there are some inconveniences, such as a need for a special collection device for collecting the reaction product and/or the product, and a need to stop the chemical reaction during the collection.

It is desirable to provide a depolymerization reaction monitoring device capable of efficiently identifying progress of a depolymerization reaction.

Hereinafter, an embodiment for carrying out the present invention (hereinafter, also referred to as an embodiment) will be described in detail with reference to the drawings. In the description and/or the drawings, identical or equivalent components, members, and processes are denoted by the same reference numerals, and overlapping description is omitted. The scale or shape of each part that is shown in the drawings is conveniently set for simplicity and ease of description and is not limitedly interpreted unless otherwise specified. The embodiment is exemplary and does not limit the scope of the present invention in any way. All features to be described in the embodiment and combinations thereof are not necessarily essential to the present invention.

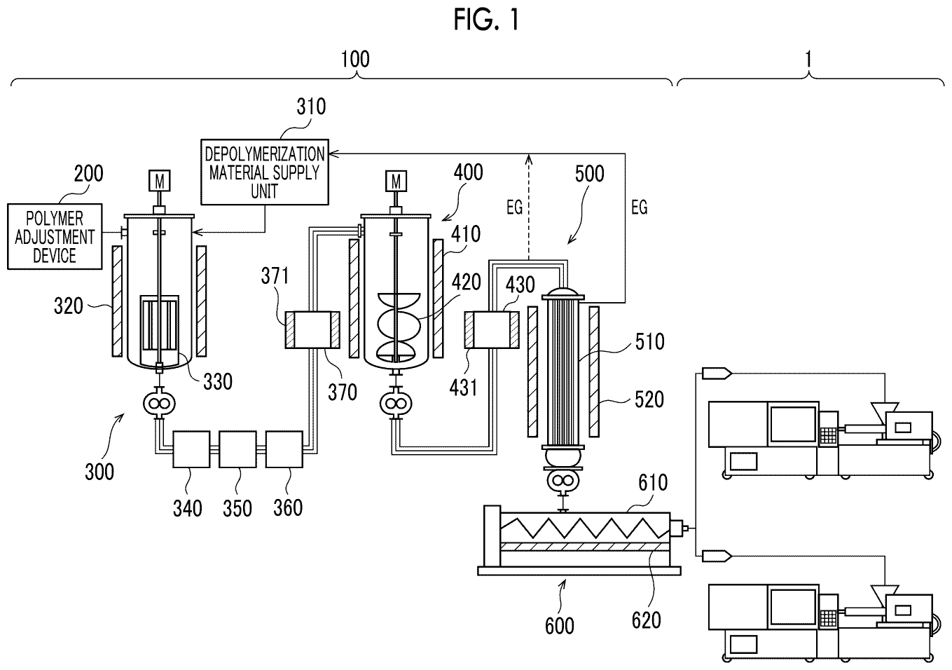

FIG. 1 schematically shows a configuration of a chemical recycling molding system to which a depolymerization reaction monitoring device according to an embodiment of the present invention can be applied. The chemical recycling molding system includes a chemical recycling device 100 and an injection molding machine 1. The chemical recycling device 100 includes a polymer adjustment device 200, a depolymerization reaction tank 300, a polymerization reaction tank 400, a by-product removal device 500, and a polymer supply unit 600. The number of injection molding machines 1 (two are schematically shown in FIG. 1), the number of polymer adjustment devices 200, the number of depolymerization reaction tanks 300, the number of polymerization reaction tanks 400, the number of by-product removal devices 500, and the number of polymer supply units 600 are optional. In particular, by increasing the number of injection molding machines 1 and polymerization reaction tanks 400, which typically have slower processing speeds or reaction rates than other processing units, the processing performance can be improved so that these processing units do not become serious bottlenecks.

The polymer adjustment device 200 adjusts a polymer such as PET that constitutes a first molding product such as a PET bottle for the depolymerization reaction tank 300 in a subsequent stage. Specifically, the polymer adjustment device 200 performs a process such as pulverizing, heating and melting, and mixing on the first molding product such as a PET bottle, and adjusts the polymer such as PET to a suitable state (phase, shape, size, and the like) for a depolymerization reaction in the depolymerization reaction tank 300. The first molding product may be any molding product other than a bottle, such as a sheet, a film, or a fiber. In addition, the polymer constituting the first molding product may be any polymer other than PET, such as polyester (including PET), polyamide, and polyurethane.

The depolymerization reaction tank 300 decomposes the polymer such as PET adjusted by the polymer adjustment device 200 into a depolymerized product through a depolymerization reaction. In a case where the polymer supplied from the polymer adjustment device 200 is PET, BHET, which is an intermediate, is obtained as the depolymerized product through the depolymerization reaction in the depolymerization reaction tank 300. The depolymerized product obtained in the depolymerization reaction tank 300 may contain a monomer of the polymer. In a case where the polymer is PET, the monomer is, for example, ethylene glycol, terephthalic acid, dimethyl terephthalate, or ethylene terephthalate. As will be described in detail later, the depolymerization reaction monitoring device according to the embodiment of the present invention may be configured to include the depolymerization reaction tank 300.

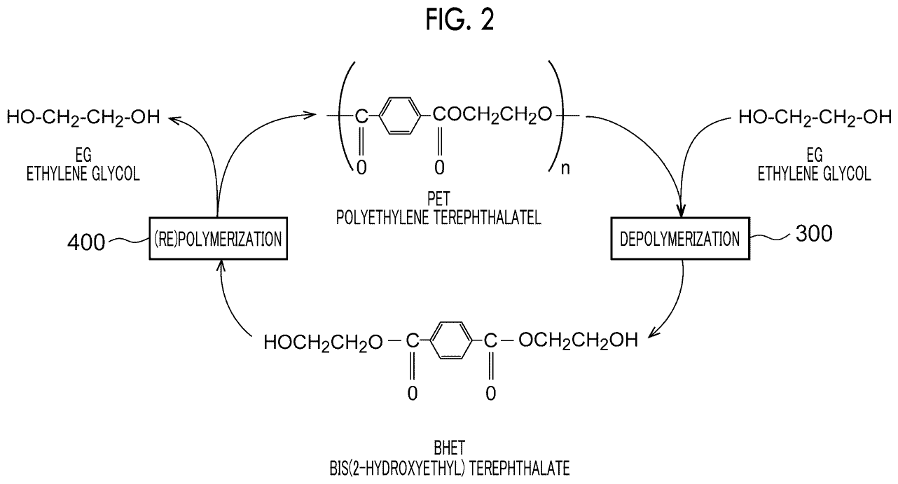

As schematically shown in FIG. 2, in the depolymerization reaction (300) of PET as a polymer, PET is decomposed by ethylene glycol (EG) as a depolymerization material supplied from a depolymerization material supply unit 310 (FIG. 1) to the depolymerization reaction tank 300, and BHET as a depolymerized product is obtained. In addition, instead of or in addition to the depolymerization material supply unit 310, EG may be supplied in the polymer adjustment device 200. In order to promote such a depolymerization reaction, an inside of the depolymerization reaction tank 300 is maintained at a suitable temperature for the depolymerization reaction by a heating unit 320 (FIG. 1) or a temperature maintaining unit that is provided in conjunction with the depolymerization reaction tank 300. A suitable temperature for the depolymerization reaction of the PET to the BHET in FIG. 2 is between 180° C. and 250° C., is preferably between 230°° C. and 245° C., and is more preferably between 235° C. and 240° C. In addition, a suitable pressure for the depolymerization reaction of the PET to the BHET in FIG. 2 is between normal pressure (0 MPa, G) and 0.8 MPa, G, is preferably between 0.4 MPa, G and 0.6 MPa, G, and is more preferably between 0.45 MPa, G and 0.55 MPa, G. Note that the unit of pressure, MPa, G, refers to gauge pressure. The pressure in the depolymerization reaction tank 300 is adjusted by a pump (not shown) or the like that is provided in conjunction with the depolymerization reaction tank 300.

A viscosity of a fluid in the depolymerization reaction tank 300 in which BHET having a smaller molecular weight than PET, which is a polymer, is generated is lower than a viscosity of a fluid in the polymerization reaction tank 400, which will be described later, in which PET having a larger molecular weight is generated. Therefore, a stirring blade 330 for stirring the fluid in the depolymerization reaction tank 300 to promote the depolymerization reaction is used for low viscosity. A propeller blade, a disc turbine blade, and a paddle blade are exemplified as the stirring blade 330 for low viscosity.

In the subsequent stage of the depolymerization reaction tank 300, foreign matter removal devices 340, 350, and 360 for removing foreign matter from the fluid mainly composed of BHET as the depolymerized product are provided. The foreign matter removal device 340 removes a resin and/or a depolymerized product different from a target resin such as PET by using principles of floating separation and sedimentation removal. A colored material removal device 350 removes a colored material by using activated carbon or the like. A metal ion removal device 360 removes metal ions by means of a principle such as ion exchange. A buffer tank 370 is provided in the subsequent stage of the foreign matter removal devices 340, 350, 360 in order to temporarily store the fluid mainly composed of BHET or the like after the foreign matter is removed before supplying the fluid to the polymerization reaction tank 400.

A first preheater 371 may be provided in the buffer tank 370 for heating or maintaining the temperature of the depolymerized product (a fluid mainly composed of BHET, or the like) before it is supplied to the subsequent stage polymerization reaction tank 400. The first preheater 371 may maintain the depolymerized product at the same temperature (between 180° C. and 250° C.) as that of the heating unit 320 provided in conjunction with the depolymerization reaction tank 300, or may maintain the depolymerized product at a temperature suitable for a polymerization reaction (between 250° C. and 300° C.), which is the same as that of a heating unit 410 provided in conjunction with the polymerization reaction tank 400 which will be described later. In this way, by providing the buffer tank 370 including a preheating mechanism (first preheater 371) as needed in the preceding stage of the polymerization reaction tank 400, it is possible to store the depolymerized product waiting to be fed to the polymerization reaction tank 400, which typically has a slower processing speed or reaction rate than other processing units such as the depolymerization reaction tank 300 and the by-product removal device 500, which will be described later, while maintaining the depolymerized product at an appropriate temperature. As a result, the capacity of the entire chemical recycling device 100 can be increased, and the chemical recycling device 100 can be stably and continuously operated (without causing so-called “resin shortage”) while an appropriate amount of a reaction product is timely supplied to each of the processing units such as the depolymerization reaction tank 300, the polymerization reaction tank 400, the by-product removal device 500, and the polymer supply unit 600. The preheating mechanism such as the first preheater 371 is not limited to the buffer tank 370, and may be provided at any location (for example, the foreign matter removal devices 340, 350, and 360) between the depolymerization reaction tank 300 and the polymerization reaction tank 400 in any mode.

The polymerization reaction tank 400 synthesizes the depolymerized product such as BHET, which is generated in the depolymerization reaction tank 300 and from which the foreign matter is removed by the foreign matter removal devices 340, 350, and 360, into the polymer through the polymerization reaction. In a case where the depolymerized product generated in the depolymerization reaction tank 300 is BHET, PET, which is the polymer, is obtained again through the polymerization reaction in the polymerization reaction tank 400.

As schematically shown in FIG. 2, EG as a by-product is generated together with PET as a main product, which is a polymer, in the polymerization reaction (400) of BHET as the depolymerized product. The EG may be circulated to the depolymerization material supply unit 310 and used for the depolymerization reaction of PET in the depolymerization reaction tank 300. Since the EG generated in the polymerization reaction tank 400 can be reused on the spot (in the depolymerization reaction tank 300) without being wasted, the operating efficiency of the chemical recycling device 100 can be improved. In particular, the amount of EG to be purchased for the depolymerization reaction of PET in the depolymerization reaction tank 300 can be significantly reduced, so that the operating cost of the chemical recycling device 100 can be reduced.

In order to promote the polymerization reaction as described above, an inside of the polymerization reaction tank 400 is maintained at a suitable temperature for the polymerization reaction by the heating unit 410 (FIG. 1) or the temperature maintaining unit serving as a second heating unit that is provided in conjunction with the polymerization reaction tank 400. The suitable temperature for the polymerization reaction of BHET to PET in FIG. 2 is between 250° C. and 300° C., is preferably between 260° C. and 290° C., and is more preferably between 270° C. and 280° C. Here, a polymerization heating temperature by the heating unit 410 that is provided in conjunction with the polymerization reaction tank 400 is higher than a depolymerization heating temperature by the heating unit 320 that is provided in conjunction with the depolymerization reaction tank 300. Although PET having a large molecular weight and a high melting point is generated in the polymerization reaction tank 400, the temperature of the polymerization reaction tank 400 is maintained higher than a temperature of the depolymerization reaction tank 300 in which BHET having a small molecular weight and a low melting point is generated, so that PET, which is the main product of the polymerization reaction tank 400, is maintained in a molten state. It is preferable that the polymerization reaction of BHET to PET in FIG. 2 is performed in a vacuum state. For this reason, the polymerization reaction tank 400 is provided in conjunction with a vacuum pump or the like (not shown).

The viscosity of the fluid in the polymerization reaction tank 400 in which the PET having a large molecular weight is generated is higher than the viscosity of the fluid in the depolymerization reaction tank 300 in which the BHET having a smaller molecular weight than the PET, which is the polymer, is generated. Therefore, a stirring blade 420 for stirring the fluid in the polymerization reaction tank 400 to promote the polymerization reaction is used for high viscosity. Examples of the stirring blade 420 for high viscosity include an anchor blade and a helical ribbon blade.

As a numerical value correlated with a degree of polymerization of the polymer such as PET, an intrinsic viscosity (IV) value or an inherent viscosity is known. The IV value (dL/g) is also used as an index for the use of the polymer, and in PET, an IV value of about 0.72 or more can be used for a bottle, an IV value of about 0.65 or more can be used for a sheet, a film, or the like, and an IV value of about 0.58 or more can be used for fibers. In the present embodiment, it is desirable to finally obtain PET having an IV value that can be used for a bottle or a sheet. As will be described later, the IV value of the PET synthesized in the polymerization reaction tank 400 may be relatively low because the IV value is also increased in the by-product removal device 500 in the subsequent stage of the polymerization reaction tank 400. Specifically, the IV value of the PET synthesized in the polymerization reaction tank 400 is between 0.2 and 0.7, is preferably between 0.3 and 0.7, and is more preferably between 0.3 and 0.55.

A buffer tank 430 that temporarily stores the polymer synthesized in the polymerization reaction tank 400 before supplying the polymer to the by-product removal device 500 in the subsequent stage and/or the polymer supply unit 600 may be provided in the subsequent stage of the polymerization reaction tank 400. A second preheater 431 may be provided in the buffer tank 430 for heating or maintaining the temperature of the polymer before it is supplied to the subsequent stage by-product removal device 500 and/or the polymer supply unit 600. The second preheater 431 may maintain the polymer at the same temperature (between 250° C. and 300° C.) as that of the heating unit 410 that is provided in conjunction with the polymerization reaction tank 400, may maintain the polymer at a suitable temperature (between 250° C. and 290° C.) for the polymerization reaction, which is the same as that of a heating unit 520 that is provided in conjunction with the by-product removal device 500 which will be described later, or may maintain the polymer at the same temperature (between 250° C. and 290° C.) as that of a heating unit 620 that is provided in conjunction with the polymer supply unit 600 which will be described later.

In this way, by providing the buffer tank 430 including the preheating mechanism (second preheater 431) as needed in the preceding stage of the by-product removal device 500 and/or the polymer supply unit 600, it is possible to store the polymer waiting to be fed to the by-product removal device 500 and/or the polymer supply unit 600 while maintaining the polymer at an appropriate temperature. As a result, the capacity of the entire chemical recycling device 100 can be increased, and the chemical recycling device 100 can be stably and continuously operated (without causing so-called “resin shortage”) while an appropriate amount of a reaction product is timely supplied to each of the processing units such as the depolymerization reaction tank 300, the polymerization reaction tank 400, the by-product removal device 500, and the polymer supply unit 600. The preheating mechanism such as the second preheater 431 is not limited to the buffer tank 430, and may be provided at any location between the polymerization reaction tank 400 and the by-product removal device 500 and/or at any location between the by-product removal device 500 and the polymer supply unit 600 in any mode.

In the subsequent stage of the polymerization reaction tank 400 (and a preceding stage of the polymer supply unit 600, which will be described later), the by-product removal device 500 is provided through which PET (main product) and EG (by-product) generated through the polymerization reaction in the polymerization reaction tank 400 pass and which removes the EG as the by-product. The by-product removal device 500 in the shown example includes a large number of linear members 510 extending downward from above. Due to the increased surface area provided by the large number of linear members 510, the volatilization of EG adhering to the surface of each linear member 510 is promoted, and the EG is effectively separated and removed from the high-viscosity PET.

The EG may be circulated to the depolymerization material supply unit 310 and used for the depolymerization reaction of PET in the depolymerization reaction tank 300. Since the EG separated and removed in the by-product removal device 500 can be reused on the spot (in the depolymerization reaction tank 300) without being wasted, the operating efficiency of the chemical recycling device 100 can be improved. In particular, the amount of EG to be purchased for the depolymerization reaction of PET in the depolymerization reaction tank 300 can be significantly reduced, so that the operating cost of the chemical recycling device 100 can be reduced.

In addition, the PET having a relatively low degree of polymerization (that is, an IV value) and the BHET which is unreacted in the polymerization reaction tank 400 also adhere to the surface of each of the linear members 510, so that the polymerization reaction similar to that in the polymerization reaction tank 400 effectively progresses due to a large surface area. For this reason, the IV value of the PET as the main product is increased by passing through the by-product removal device 500. Specifically, the IV value of the PET after passing through the by-product removal device 500 is 0.7 or more, is preferably 0.8 or more, and is more preferably 0.85 or more.

In order to promote such a polymerization reaction, an inside of the by-product removal device 500 is maintained at a suitable temperature for the polymerization reaction by the heating unit 520 (FIG. 1) or the temperature maintaining unit serving as the second heating unit that is provided in conjunction with the by-product removal device 500. Specifically, the heating temperature by the heating unit 520 is between 250° C. and 290°° C., and preferably between 260° C. and 280° C. Here, the heating temperature by the heating unit 520 that is provided in conjunction with the by-product removal device 500 is preferably higher than a polymerization heating temperature by the heating unit 410 that is provided in conjunction with the polymerization reaction tank 400. In the by-product removal device 500, the polymerization reaction progresses further than in the polymerization reaction tank 400, resulting in a larger molecular weight of PET as a polymer and a higher melting point. By maintaining a higher temperature inside the by-product removal device 500 than inside the polymerization reaction tank 400, the PET as a product of the by-product removal device 500 can be maintained in a molten state. A heating unit or a temperature maintaining unit, serving as a second heating unit, for heating or maintaining the temperature at least at the polymerization heating temperature by the heating unit 410 that is provided in conjunction with the polymerization reaction tank 400 may be provided around a pipe or the like between the polymerization reaction tank 400 and the by-product removal device 500. Further, it is preferable that the polymerization reaction in the by-product removal device 500 is performed in a vacuum state in the same manner as the polymerization reaction in the polymerization reaction tank 400. For this reason, the by-product removal device 500 is provided conjunction with a vacuum pump or the like (not shown). The EG as the by-product can be efficiently removed by setting the inside of the by-product removal device 500 in a vacuum state (reduced pressure state).

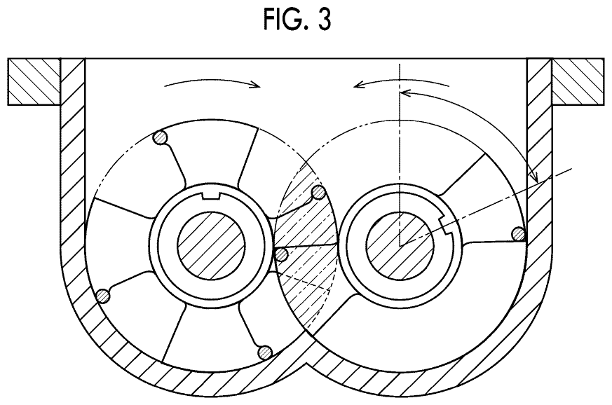

The configuration of the by-product removal device 500 is not limited to a “vertical type” as shown in FIG. 1. For example, a stirring device of a “two-shaft horizontal type” as shown in FIG. 3 may be used as the by-product removal device 500. The stirring device includes two rotary shafts extending in a direction perpendicular to the paper surface of FIG. 3, and two stirring blades that rotate around each of the rotary shafts to stir PET and EG as stirring targets. The volatilization of the EG is promoted by being stirred by the two stirring blades, so that the EG is effectively separated and removed from the high-viscosity PET. The details of the stirring device in FIG. 3 are disclosed in Japanese Patent No. 2925599, which is incorporated herein by reference.

The polymer supply unit 600 supplies the polymer such as PET synthesized in the polymerization reaction tank 400 (or the polymerization reaction tank 400 and the by-product removal device 500) to the injection molding machine 1 that molds the second molding product such as a PET bottle. The polymer supply unit 600 includes a transfer pump 610 such as a gear pump or a screw pump suitable for supplying the high-purity and high-viscosity (that is, high degree of polymerization or high IV value) PET from which the EG as the by-product is removed in the by-product removal device 500 to the injection molding machine 1 in a molten state.

The polymer supply unit 600 is provided with the heating unit 620 or the temperature maintaining unit as a first heating unit for heating or maintaining the temperature of the polymer such as PET to be transferred to the injection molding machine 1 by the transfer pump 610 to maintain it in a molten state. Specifically, the heating temperature by the heating unit 620 is between 250° C. and 290° C., and preferably between 260° C. and 280° C. Here, the heating temperature (first heating temperature) by the heating unit 620 (first heating unit) provided in the polymer supply unit 600 is preferably higher than a second heating temperature by the second heating unit such as the heating unit 410 provided in conjunction with the polymerization reaction tank 400, the heating unit 520 provided in conjunction with the by-product removal device 500, and a heating unit (not shown) provided between the polymerization reaction tank 400 and the by-product removal device 500. The polymerization reaction that begins in the polymerization reaction tank 400 gradually progresses and is completed in the by-product removal device 500. As a result, the molecular weight of the polymer such as PET in the polymer supply unit 600 becomes larger, and the melting point thereof becomes higher than in the polymerization reaction tank 400 and the by-product removal device 500. Therefore, by making the first heating temperature in the polymer supply unit 600 higher than the previous second heating temperature, the polymer such as PET having a high viscosity (that is, high degree of polymerization or high IV value) and a high melting point can be maintained in a molten state.

A temperature gradient may be provided such that the heating temperature increases stepwise from the polymerization reaction tank 400 to the polymer supply unit 600. For example, by making the heating temperature by a heating unit (not shown) provided between the polymerization reaction tank 400 and the by-product removal device 500 higher than the heating temperature by the heating unit 410 provided in conjunction with the polymerization reaction tank 400, making the heating temperature by the heating unit 520 provided in conjunction with the by-product removal device 500 higher than the heating temperature by the heating unit (not shown), and making the heating temperature by the heating unit 620 provided in the polymer supply unit 600 higher than the heating temperature by the heating unit 520, it is possible to reliably maintain the polymer such as PET, whose melting point increases from the polymerization reaction tank 400 to the polymer supply unit 600, in a molten state. A heating unit for heating or maintaining the temperature of the polymer such as PET to maintain it in a molten state may be provided between the polymer supply unit 600 and the injection molding machine 1.

The injection molding machine 1 molds the polymer, such as PET, in a molten state generated by the chemical recycling device 100 into a second molding product. The second molding product may be the same as or different from the first molding product that is subjected to a pulverizing process or the like by the polymer adjustment device 200. For example, the first molding product and the second molding product may both be PET bottles. In addition, one of the first molding product and the second molding product may be a PET bottle, and the other may be a molding product other than a bottle, such as a sheet, a film, and a fiber. In general, in mechanical recycling, the IV value of the second molding product after recycling becomes lower than the IV value of the first molding product before recycling. However, according to the chemical recycling device 100 of the present embodiment including the mechanism for increasing the IV values such as the foreign matter removal devices 340, 350, and 360 and the by-product removal device 500, it is also possible to increase the IV value of the second molding product after recycling to be higher than the IV value of the first molding product before recycling. For example, according to the present embodiment, the PET fiber having a low IV value as the first molding product can be recycled into the PET bottle having a high IV value as the second molding product.

The injection molding machine 1 molds a molten resin such as PET into a second molding product. An injection molding machine that uses a molten resin as a raw material is disclosed in, for example, the related art. The present application incorporates by reference the entire contents of the literature (Japanese Patent Application No. 2020-130985) filed on Jul. 31, 2020. As schematically shown in FIG. 1, a plurality of the injection molding machines 1 may be provided in parallel. The molding machine to which the molten resin or the like is supplied from the chemical recycling device 100 is not limited to an injection molding machine, and may be any molding machine (for example, a compression molding machine).

In the present embodiment as described above, the polymer resynthesized in the polymerization reaction tank 400 is not made into flakes or pellets, and is supplied as it is to the injection molding machine 1 by the polymer supply unit 600. Since the cooling process and the heating process related to the flakes or the pellets as in the related art are not required, the molding product such as a PET bottle can be recycled with less energy as compared with the related art.

In the chemical recycling device 100 according to the present embodiment, since the polymer resynthesized in the polymerization reaction tank 400 is supplied as it is to the injection molding machine 1, it is necessary to quickly realize the IV value of the polymer required for the molding product (second molding product). In the present embodiment, the by-product removal device 500 capable of promoting the polymerization reaction and increasing the IV value of the polymer is provided in addition to the polymerization reaction tank 400. Therefore, the by-product removal device 500 can sufficiently meet such a requirement.

In the example of FIG. 1, only one of each of the polymer adjustment device 200, the depolymerization reaction tank 300, the polymerization reaction tank 400, the by-product removal device 500, the polymer supply unit 600, and the like is provided, but a plurality of each of them may be provided. The plurality of processing units can execute the same processing in parallel, so that the processing performance of the processing unit group can be improved. In addition, the difference in the processing speed or the reaction rate between the processing units can be reduced by increasing the number of the slow processing units.

In addition, one or a plurality of the processing units may accept an external material that is procured from a location or a facility different from the chemical recycling molding system shown in FIG. 1 instead of or in addition to the material from the processing unit in the preceding stage. For example, in a case where a plurality of the polymerization reaction tanks 400 are provided, some of the polymerization reaction tanks 400 may be supplied with the depolymerized product from the depolymerization reaction tank 300, and the others may be supplied with the depolymerized product (synonymous with the depolymerized product supplied from a depolymerized product supply unit 300A which will be described later) procured from the outside. Similarly, in a case where a plurality of the by-product removal devices 500 and/or the polymer supply units 600 are provided, some of the by-product removal devices 500 and/or the polymer supply units 600 may be supplied with the polymer from the polymerization reaction tank 400, and the others may be supplied with the polymer (synonymous with the polymer supplied from a polymer supply unit 400A which will be described later) procured from the outside. In this way, by allowing the acceptance of the external material at each stage of the processing in the chemical recycling molding system, the flexibility of the chemical recycling molding system can be ensured, and the system can efficiently operate.

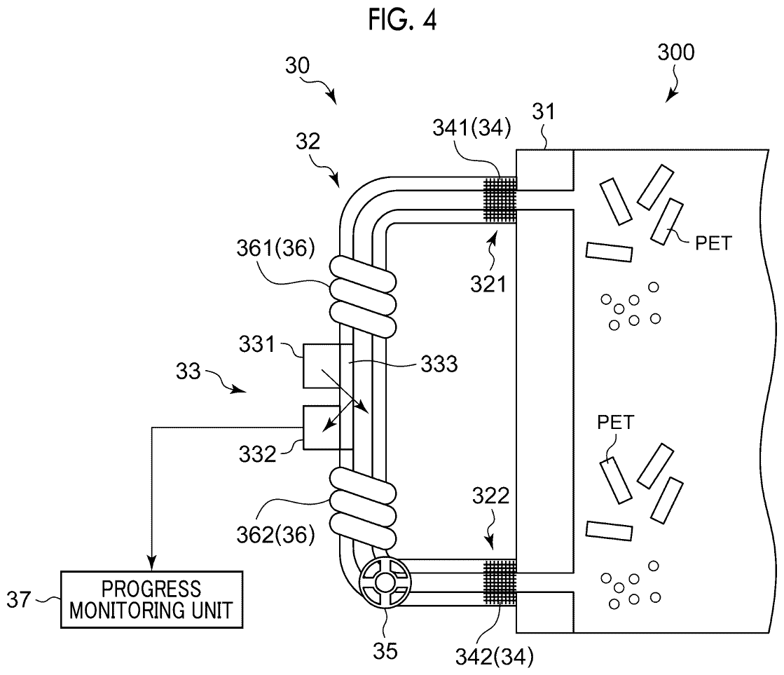

FIG. 4 shows one embodiment of a depolymerization reaction monitoring device 30 according to the present invention. The depolymerization reaction monitoring device 30 is configured to include the above-described depolymerization reaction tank 300. The depolymerization reaction tank 300 causes a depolymerization reaction in which the polyester is decomposed into a depolymerized product by using the depolymerization material. In the present embodiment, as in FIG. 2, the polyester is polyethylene terephthalate (PET), the depolymerization material is ethylene glycol (EG), and the depolymerized product is bis(2-hydroxyethyl) terephthalate (BHET).

However, the present invention is also applicable to combinations of the polyester, the depolymerization material, and the depolymerized product different from these. For example, the polyester may be polypropylene terephthalate (PPT), the depolymerization material may be the propylene glycol (PG), and the depolymerized product may be bis(2-hydroxypropyl) terephthalate (BHPT). In addition, the polyester may be polybutylene terephthalate (PBT), the depolymerization material may be the butylene glycol (BG), and the depolymerized product may be bis(2-hydroxybutyl) terephthalate (BHBT). Such a combination of the polyester, the depolymerization material, and the depolymerized product has a common feature in that the depolymerized product (BHET, BHPT, BHBT, or the like), which is the product of the depolymerization reaction, is dissolved in the depolymerization material (EG, PG, BG, or the like), which is one of the reaction products or the catalyst in the depolymerization reaction, while the polyester (PET, PPT, PBT, or the like), which is the other reaction product of the depolymerization reaction, is not dissolved in the depolymerization material (EG, PG, BG, or the like).

In addition, as long as the same features are observed, the depolymerization reaction monitoring device 30 according to the present embodiment may be used to monitor the progress of the depolymerization reaction of a polymer other than a polyester, such as a polyamide or a polyurethane. That is, the depolymerization reaction monitoring device 30 according to the present embodiment is applicable as long as the depolymerized product, which is a product of the depolymerization reaction, is dissolved in the depolymerization material, which is one of the reaction products or the catalyst of the depolymerization reaction, while the polymer, which is the other reaction product of the depolymerization reaction, is not dissolved in the depolymerization material.

In this way, the depolymerization reaction monitoring device 30 according to the present embodiment as described above is not limited to the depolymerization reaction tank 300 provided in the chemical recycling molding system shown in FIG. 1, and is applicable to the depolymerization reaction tank 300 provided in any system or any standalone depolymerization reaction tank 300. In addition, the depolymerization reaction monitoring device 30 in the example of FIG. 4 is provided only one on a side portion of the depolymerization reaction tank 300, but may be provided in any number (for example, a plurality) at any portion (for example, a bottom surface) not limited to the side portion of the depolymerization reaction tank 300. In addition, the depolymerization reaction monitoring device 30 may be provided in the subsequent stage of the depolymerization reaction tank 300 and the preceding stage of the polymerization reaction tank 400. For example, the depolymerization reaction monitoring device 30 may be provided in a pipe between the depolymerization reaction tank 300 and the polymerization reaction tank 400 in FIG. 1 or in the buffer tank 370 in addition to or instead of the depolymerization reaction tank 300. In a case where a plurality of depolymerization reaction tanks 300 are connected in parallel, an average value of the degree of progress of the depolymerization reaction in the plurality of depolymerization reaction tanks 300 can be identified in the buffer tank 370 or the like in which the depolymerization product liquid is collected in a subsequent stage of the plurality of depolymerization reaction tanks 300.

In a case where the plurality of depolymerization reaction tanks 300 are connected in series or in parallel, any number of the depolymerization reaction monitoring devices 30 may be provided at any portion of each of the depolymerization reaction tanks 300. It is preferable that the monitoring results (in particular, the measurement results obtained by the characteristic measuring unit 33, which will be described later, or the monitoring results obtained by the progress monitoring unit 37) obtained by the respective depolymerization reaction monitoring devices 30 in the respective depolymerization reaction tanks 300 are shared or listed between the plurality of depolymerization reaction tanks 300. For example, in a case where the plurality of depolymerization reaction tanks 300 are connected in series, the degree of progress in each phase of the depolymerization reaction can be accurately identified by each of the depolymerization reaction monitoring devices 30 provided in each of the depolymerization reaction tanks 300. The residence time of the reaction liquid and/or the product liquid in each of the depolymerization reaction tanks 300, as well as the movement timing and the movement speed of the reaction liquid and/or the product liquid between the adjacent depolymerization reaction tanks 300, may be adaptively adjusted according to the degree of progress of the depolymerization reaction in each of such phases.

The depolymerization reaction tank 300 includes a tank main body 31 in which the depolymerization reaction of the polyester or a polymer occurs, and a depolymerization material flow portion 32 through which a depolymerization material such as EG flows between the tank main body 31 and the depolymerization material flow portion 32. The depolymerization material flow portion 32 constitutes a flow path of the depolymerization material such as EG outside the tank main body 31. As shown in the drawings, one end 321 and the other end 322 of the tubular depolymerization material flow portion 32 are connected to different locations of the tank main body 31. As will be described later, the depolymerization material such as EG may flow from the one end 321 toward the other end 322 of the depolymerization material flow portion 32, or may flow from the other end 322 toward the one end 321 of the depolymerization material flow portion 32.

The depolymerization material flow portion 32 is provided with the characteristic measuring unit 33, an intrusion prevention unit 34, a direction switching unit 35, and a cooling unit 36.

The characteristic measuring unit 33 measures characteristics of a depolymerization material such as EG in which a depolymerized product such as BHET is dissolved at the depolymerization reaction tank 300. Specifically, the characteristic measuring unit 33 measures the characteristics of the depolymerization material such as EG in the depolymerization material flow portion 32.

The characteristic measuring unit 33 in the example of FIG. 4 measures optical characteristics of the depolymerization material such as EG in the depolymerization material flow portion 32. The characteristic measuring unit 33 includes a light source 331, a light receiving unit 332, and a window 333. The light source 331 emits light of any intensity, pattern, wavenumber, wavelength, frequency, or other aspect suitable for measuring the optical characteristics of the depolymerization material such as EG in which the depolymerized product such as BHET is dissolved. The light from the light source 331 passes through a light-transmitting window 333 that forms a part of a tube wall of the tubular depolymerization material flow portion 32, and enters the inside of the depolymerization material flow portion 32 to be irradiated to the depolymerization material such as EG. The light is subjected to optical actions such as reflection, refraction, absorption, scattering, diffraction, polarization, interference, and dispersion according to the optical characteristics of the depolymerization material such as EG in which the depolymerized product such as BHET is dissolved. The light receiving unit 332 receives the light that has been subjected to such an optical action through the window 333. As a preferable material for the window 333, borosilicate glass, cobalt glass, quartz, and aluminosilicate glass are exemplified. The light received by the light receiving unit 332 represents the optical characteristics of the depolymerization material such as EG in which the depolymerized product such as BHET is dissolved. As the optical characteristics that can be measured by the characteristic measuring unit 33, a refractive index and a spectrum are exemplified. In the present embodiment, an example in which the characteristic measuring unit 33 measures the refractive index of the depolymerization material such as EG in which the depolymerized product such as BHET is dissolved will be described.

The refractive index measured by the characteristic measuring unit 33 is provided to a progress monitoring unit 37 constituted by a computer or a processor. The progress monitoring unit 37 monitors the progress of the depolymerization reaction in the depolymerization reaction tank 300 (particularly the tank main body 31) based on the optical characteristics and other characteristics such as the refractive index of the depolymerization material such as EG, which are measured by the characteristic measuring unit 33.

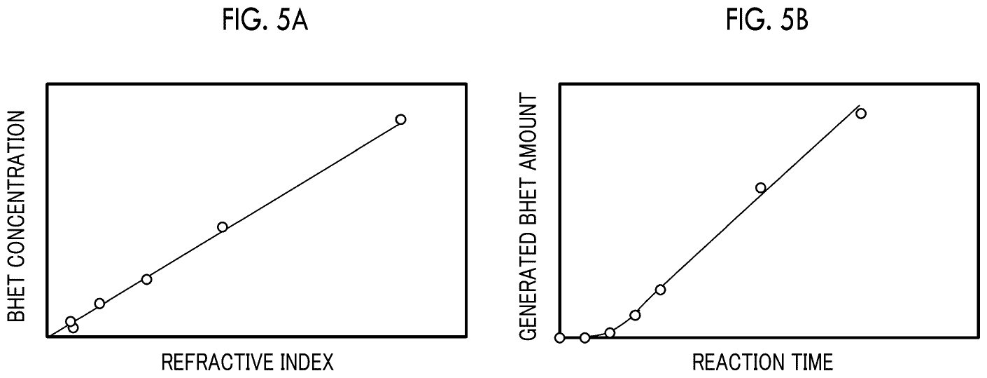

FIG. 5A and FIG. 5B show examples of monitoring progress of the depolymerization reaction by the progress monitoring unit 37. As shown in FIG. 5A, there is a correlation such as a proportional relationship between the refractive index measured by the characteristic measuring unit 33 and the concentration of the depolymerized product such as BHET in the depolymerization material such as EG, which is a measurement target (points (○) in FIG. 5A are examples of actual measurement values). As described above, in the depolymerization reaction tank 300 (particularly the tank main body 31), PET is decomposed by EG as the depolymerization material, and BHET as the depolymerized product is obtained. Therefore, the concentration of BHET represents the progress of the depolymerization reaction of PET. That is, the progress monitoring unit 37 can recognize the progress of the depolymerization reaction of the polymer such as PET, based on the concentration of the depolymerized product such as BHET, which is identified based on the correlation as shown in FIG. 5A, from the refractive index measured by the characteristic measuring unit 33. For example, as shown in FIG. 5B, the progress monitoring unit 37 obtains the total amount of BHET generated in the depolymerization reaction tank 300 based on the concentration of BHET that can be recognized from FIG. 5A, and expresses the amount as a time-dependent change with respect to a reaction time (points (○) in FIG. 5B are examples of actual measurement values). The monitoring result of the progress monitoring unit 37 as shown in FIGS. 5A and 5B may be provided to controllers for controlling the chemical recycling molding system and the chemical recycling device 100 in FIG. 1, or may be displayed on a management screen or an operation screen that can be viewed by managers or operators.

The characteristic measuring unit 33 measures non-optical characteristics of a depolymerization material such as EG in which a depolymerized product such as BHET is dissolved. For example, the characteristic measuring unit 33 may measure electrical characteristics of a depolymerization material such as EG in which a depolymerized product such as BHET is dissolved at the depolymerization reaction tank 300. In this case, instead of the optical characteristic measuring unit 33 in FIG. 4, a characteristic measuring unit including an electrode that interacts (for example, comes into contact) electrically with the depolymerization material such as EG in the depolymerization material flow portion 32 is provided. In addition, a method of the characteristic measuring unit 33 is not limited as long as it can measure the characteristics without collecting the depolymerization material such as EG from the depolymerization material flow portion 32 (depolymerization reaction tank 300).

Further, in a case where a polymer such as PET that remains without dissolving in the depolymerization material such as EG in the tank main body 31 does not hinder the measurement, the characteristic measuring unit 33 may be provided in conjunction with the tank main body 31, instead of the depolymerization material flow portion 32. However, for the optical characteristic measuring unit 33 as shown in FIG. 4, since the remaining polymer such as PET has an undesirable action such as diffuse reflection on the measurement light, it is preferable that the characteristic measuring unit 33 is provided in the depolymerization material flow portion 32 outside the tank main body 31, and it is more preferable that an intrusion prevention unit 34 to be described below is provided.

The intrusion prevention unit 34 includes a first filter 341 provided on the one end 321 side of the tubular depolymerization material flow portion 32 and a second filter 342 provided on the other end 322 side of the tubular depolymerization material flow portion 32. The first filter 341 and the second filter 342 prevent insoluble matter that is not dissolved in the depolymerization material such as EG from intruding from the tank main body 31 into the depolymerization material flow portion 32. As described above, examples of the insoluble matter that is not dissolved in the depolymerization material such as EG include polyesters or polymers such as PET, which are reaction products of the depolymerization reaction, and oligomers generated by partially depolymerizing the polyesters or polymers. In this way, the insoluble matter that may hinder the optical measurement of the characteristic measuring unit 33 in the depolymerization material flow portion 32 can be effectively removed by the first filter 341 and/or the second filter 342.

The direction switching unit 35 is configured to include a backwashing pump or the like that can switch a flow direction of the depolymerization material such as EG in the tubular depolymerization material flow portion 32 between a first direction from the one end 321 toward the other end 322 and a second direction from the other end 322 toward the one end 321 in order to prevent clogging of the first filter 341 and/or the second filter 342. By the direction switching unit 35 flowing the depolymerization material such as EG in the first direction, the insoluble matter collected by the second filter 342 at the other end 322 is returned to the tank main body 31, and clogging of the second filter 342 is eliminated. In addition, by the direction switching unit 35 flowing the depolymerization material such as EG in the second direction, the insoluble matter collected by the first filter 341 at the one end 321 is returned to the tank main body 31, and clogging of the first filter 341 is eliminated. In order to avoid clogging in both the first filter 341 and the second filter 342, the direction switching unit 35 preferably iteratively or periodically switches the flow direction of the depolymerization material such as EG in the depolymerization material flow portion 32 between the first direction and the second direction.

The backwashing pump or the like constituting the direction switching unit 35 may operate before the measurement or during the measurement by the characteristic measuring unit 33, and may be stopped at other times. In a case where the backwashing pump or the like that constitutes the direction switching unit 35 operates, the depolymerization material such as EG, which is the measurement target of the characteristic measuring unit 33, is taken from the tank main body 31 at the one end 321 and the other end 322 of the depolymerization material flow portion 32. In this case, the “old” depolymerization material originally present in the depolymerization material flow portion 32 is discharged into the tank main body 31 from the other of the one end 321 and the other end 322 of the depolymerization material flow portion 32, and thus the clogging of the other of the first filter 341 and the second filter 342 provided therein is eliminated. Then, the characteristic measuring unit 33 can measure the “new” depolymerization material newly taken from the tank main body 31.

The cooling unit 36 cools the depolymerization material such as EG in the tubular depolymerization material flow portion 32. The optical characteristics and other characteristics such as the refractive index that can be measured by the characteristic measuring unit 33 depend on the temperature of the depolymerization material such as EG, which is a measurement target. Therefore, the cooling unit 36 stabilizes the measurement accuracy of the characteristic measuring unit 33 by cooling the depolymerization material such as EG to a predetermined temperature before the measurement by the characteristic measuring unit 33. As described above, the cooling unit 36 preferably includes a first cooling unit 361 on the one end 321 side with respect to the characteristic measuring unit 33 and a second cooling unit 362 on the other end 322 side with respect to the characteristic measuring unit 33, since the depolymerization material such as EG in the depolymerization material flow portion 32 can flow in either the first direction or the second direction due to the direction switching unit 35.

Instead of the cooling unit 36, a heating unit that heats the depolymerization material such as EG to a predetermined temperature may be provided. However, in general, components such as the sensor constituting the characteristic measuring unit 33 have a low operating temperature (for example, 150° C. or lower) in many cases. Therefore, it may not be possible to measure the depolymerization material such as EG in the tank main body 31, for example, between 180° C. to 250° C. as it is. Therefore, it is preferable that the cooling unit 36 lowers the temperature of the depolymerization material such as EG to a measurable temperature (operating temperature) of the characteristic measuring unit 33. As shown in FIG. 4, the cooling unit 36 provided at the front and rear (or above and below) of the characteristic measuring unit 33 may cool the characteristic measuring unit 33 itself. In addition, a temperature sensor (not shown) that measures the temperature of the depolymerization material such as EG facing the characteristic measuring unit 33 may be provided. In this manner, the cooling unit 36 and/or the heating unit may be controlled such that the temperature measured by the temperature sensor approaches a predetermined temperature that can be measured by the characteristic measuring unit 33.

According to the depolymerization reaction monitoring device 30 or the progress monitoring unit 37 according to one embodiment as described above, the progress of the depolymerization reaction of the polyester or polymer in which the depolymerized product such as BHET, which is the product, is dissolved in the depolymerization material such as EG which is a reaction product or catalyst can be efficiently identified through measurement of the characteristics of the depolymerization material such as EG by the characteristic measuring unit 33 in the depolymerization reaction tank 300 (depolymerization material flow portion 32). Since it is not necessary to collect the depolymerization material such as EG, which is the measurement target, from the depolymerization reaction tank 300 (the depolymerization material flow portion 32), the progress of the depolymerization reaction can be identified in real time.

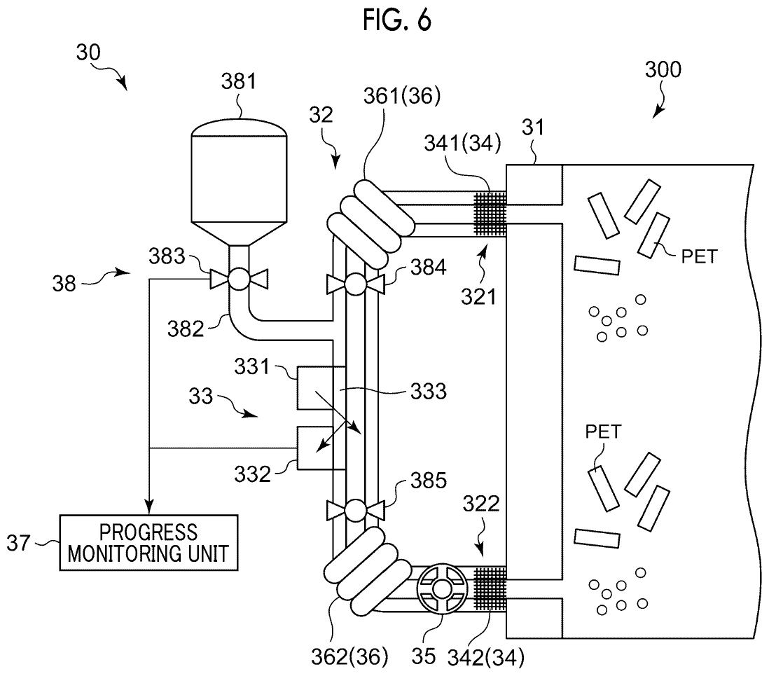

FIG. 6 shows another embodiment of the depolymerization reaction monitoring device 30 according to the present invention. The same components as those in one embodiment in FIG. 4 are denoted by the same reference numerals, and overlapping description is omitted.

The depolymerization material flow portion 32 is provided with a depolymerization material dilution unit 38 that further adds a depolymerization material such as EG to the depolymerization material such as EG in the depolymerization material flow portion 32 to dilute the depolymerization material. The depolymerization material dilution unit 38 includes a dilution depolymerization material supply unit 381 that supplies a depolymerization material for dilution such as EG, a dilution pipe 382 that connects the dilution depolymerization material supply unit 381 and the depolymerization material flow portion 32 to each other, a dilution valve 383 that is provided in the dilution pipe 382, a first valve 384 that is provided on the one end 321 side with respect to a connection portion of the depolymerization material flow portion 32 with the dilution pipe 382 and the characteristic measuring unit 33, and on the other end 322 side with respect to the first cooling unit 361, and a second valve 385 that is provided on the other end 322 side with respect to the connection portion of the depolymerization material flow portion 32 with the dilution pipe 382 and the characteristic measuring unit 33, and on the one end 321 side with respect to the second cooling unit 362.

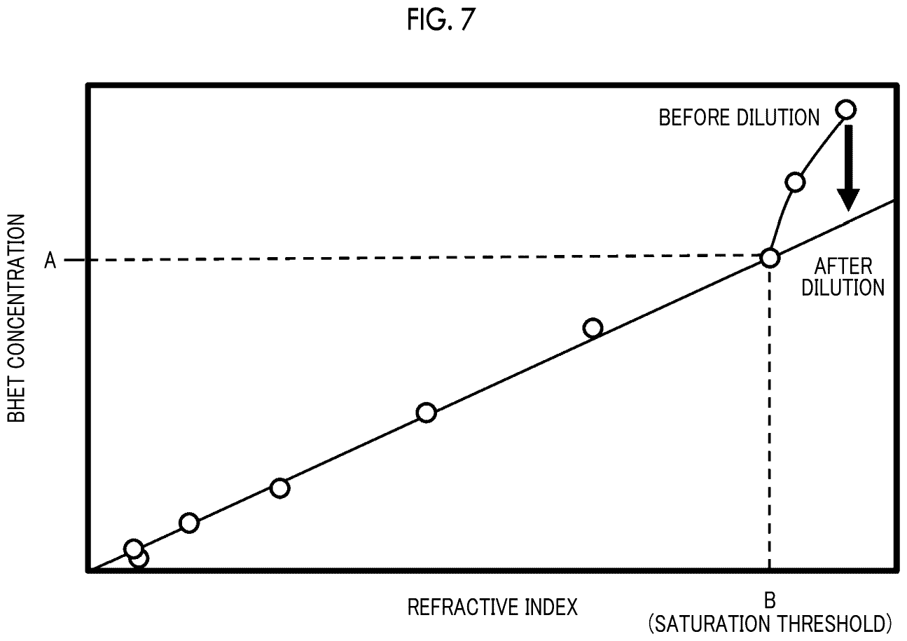

FIG. 7 shows an example of dilution of a depolymerization material by a depolymerization material dilution unit 38. As also shown in FIG. 5A, there is a correlation, such as a proportional relationship, between the refractive index of the depolymerization material such as EG in which the depolymerized product such as BHET is dissolved and the concentration of the depolymerized product such as BHET in the depolymerization material such as EG. However, as shown in FIG. 7 (before dilution), in a case where the concentration of BHET or the like exceeds a predetermined value A, this correlation collapses. For this reason, the progress monitoring unit 37 may not be able to correctly identify the concentration of BHET or the like from the refractive index measured by the characteristic measuring unit 33.

Therefore, the depolymerization material dilution unit 38 additionally supplies the depolymerization material such as EG from the dilution depolymerization material supply unit 381 to the solution of BHET or the like having such high concentration that breaks the linearity of the measurement in the characteristic measuring unit 33 in this way. As a result, the concentration of the depolymerized product such as BHET in the depolymerization material flow portion 32 (between the first valve 384 and the second valve 385) decreases, and as shown in FIG. 7 (after dilution), the correlation or linearity appears to be maintained even in a high concentration region. That is, by decreasing the concentration of the depolymerized product such as BHET in the depolymerization material flow portion 32, the refractive index measured by the characteristic measuring unit 33 falls within a linear range in FIG. 7. Then, the progress monitoring unit 37 can accurately identify the original (undiluted) concentration of BHET or the like in the tank main body 31 (concentration on the straight line “after dilution” in FIG. 7) based on the refractive index measured normally in the linear range by the characteristic measuring unit 33 and the amount of EG or the like used for dilution by the dilution depolymerization material supply unit 381 (adjusted by the dilution valve 383 as will be described later).

The dilution depolymerization material supply unit 381 may supply a depolymerization material such as EG recovered from the depolymerization material supply unit 310, the depolymerization reaction tank 300, the polymerization reaction tank 400, the by-product removal device 500, and the like in FIG. 1 as a dilution depolymerization material. Alternatively, the depolymerization material such as EG that is not used in the main processes of the chemical recycling device 100 in the depolymerization material supply unit 310, the depolymerization reaction tank 300, the polymerization reaction tank 400, the by-product removal device 500, and the like may be used as the dilution depolymerization material. The dilution depolymerization material may contain impurities as long as it contains a depolymerization material such as EG as a main component. It is preferable that such impurities do not adversely affect the depolymerization reaction and/or repolymerization reaction, characteristic measurement of the characteristic measuring unit 33, progress monitoring of the progress monitoring unit 37, by-product removal by the by-product removal device 500, or the like.

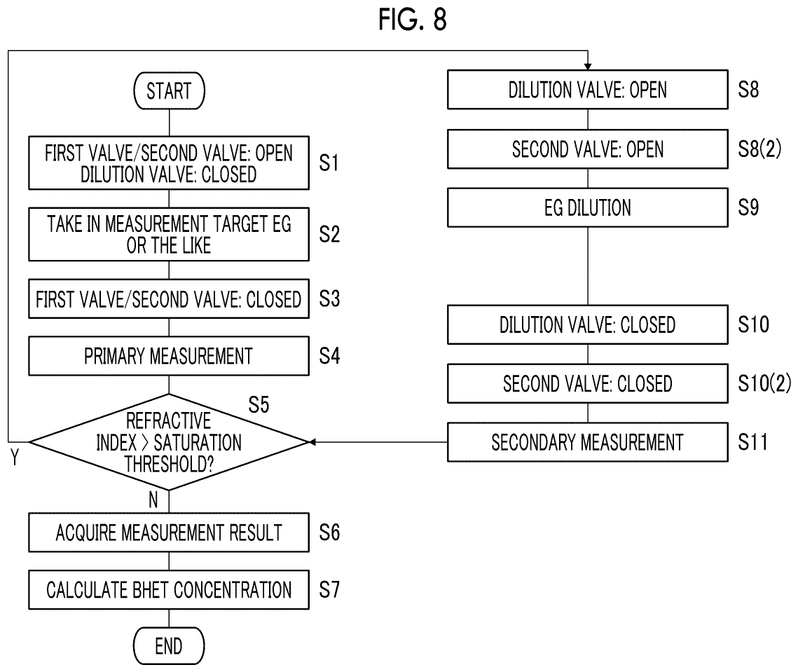

In order to improve the measurement accuracy of the characteristic measuring unit 33 in a case where the above-described depolymerization material dilution unit 38 is used, various types of valves such as the dilution valve 383, the first valve 384, and the second valve 385 are provided. Hereinafter, opening and closing operations of the respective valves will be described with reference to a flowchart of a specific example of the measurement procedure shown in FIG. 8. In the description of the flowchart, “S” means a step or a process.

In S1 at the start of the measurement, it is assumed that the first valve 384 and the second valve 385 are in an open state, and the dilution valve 383 is in a closed state. In S2, a backwashing pump or the like constituting the direction switching unit 35 operates, and the depolymerization material such as EG, which is a measurement target, is taken from the tank main body 31 to the depolymerization material flow portion 32. At this time, as described above, the first cooling unit 361 and/or the second cooling unit 362 cool the taken-in depolymerization material such as EG to a predetermined measurable temperature of the characteristic measuring unit 33. As a result, the depolymerization material such as EG cooled by the first cooling unit 361 and/or the second cooling unit 362 enters a space between the first valve 384 and the second valve 385 in the open state in S1. In S3, the first valve 384 and the second valve 385 are switched to the closed state. As a result, a closed space is temporarily formed between the first valve 384 and the second valve 385, and the total amount of BHET or the like in the closed space is determined.

In S4, the characteristic measuring unit 33 performs primary measurement of a refractive index of the depolymerization material such as EG in the closed space formed in S3. In S5, it is determined whether or not the refractive index measured in S4 exceeds a saturation threshold B shown in FIG. 7. In a case where “No” is determined in S5, the refractive index measured in S4 falls within a linear range equal to or less than the saturation threshold B and is therefore adopted as a measurement result by the characteristic measuring unit 33 in S6 as it is. In S7, the progress monitoring unit 37 calculates concentration of the depolymerized product such as BHET, based on the measurement result of the refractive index obtained in S6.

In a case where “Yes” is determined in S5, since the refractive index measured in S4 deviates from the linear range of the characteristic measuring unit 33, even though the process proceeds to S6 and S7, the correct concentration of the depolymerized product such BHET cannot be obtained. Therefore, in S8, the dilution valve 383 is switched to the open state. In the subsequent S8(2), the second valve 385 is switched to the open state in order to guide EG for dilution to the characteristic measuring unit 33. Then, in S9, the backwashing pump or the like constituting the direction switching unit 35 operates, and the EG for dilution is supplied from the dilution depolymerization material supply unit 381 to the space between the first valve 384 and the second valve 385 through the dilution valve 383 in the open state. The amount of EG or the like used for the dilution in S9 is measured by a flow rate sensor (not shown), which is provided in the dilution valve 383, or the like. In S10, the dilution valve 383 is switched to the closed state, and in S10(2), the second valve 385 is switched to the closed state. In this manner, the closed space is formed again between the first valve 384 and the second valve 385.

In S11, the characteristic measuring unit 33 performs secondary measurement of a refractive index of the depolymerization material such as EG in the closed space formed in S3 and S10(2), and the process returns to S5. In a case where “No” is determined in S5, the refractive index after dilution with EG measured in S11 falls within a linear range equal to or less than the saturation threshold B and is therefore adopted as a measurement result by the characteristic measuring unit 33 in S6 as it is. In S7, the progress monitoring unit 37 calculates the original (undiluted) concentration of BHET or the like in the tank main body 31 (concentration on the straight line “after dilution” in FIG. 7) based on the secondary measurement result of the refractive index within the linear range obtained in S11 and the amount of EG or the like used for dilution in S9. That is, as described above, the dilution valve 383, the first valve 384, and the second valve 385 can control the amount of the depolymerization material such as EG entering into the closed space (space defined by the three valves) formed in S3 from the tank main body 31 and the dilution depolymerization material supply unit 381, respectively. Therefore, the progress monitoring unit 37 can calculate the concentration of BHET or the like in the tank main body 31 while identifying a quantitative effect of the dilution by the depolymerization material dilution unit 38.

In a case where “Yes” is determined in S5, the process proceeds to S8 to S11 again, and the dilution in S9 and the secondary measurement in S11 are repeated until “No” is determined in S5, that is, until the secondary measurement result of the refractive index in S11 falls within the linear range of the saturation threshold B or less. In S7 at the end of the measurement, the first valve 384, the second valve 385, and the dilution valve 383 are in the closed state.

Not only is the amount of EG for dilution or the like supplied by the dilution depolymerization material supply unit 381 controlled by the dilution valve 383 or the like, but also the temperature thereof may be controlled. For example, by supplying the temperature-controlled EG for dilution or the like in S9 to the closed space formed in S3, the EG or the like in the closed space can be cooled to a predetermined measurable temperature of the characteristic measuring unit 33. In this way, at least a part of the function of the cooling unit 36 may be realized by the EG for dilution or the like supplied by the dilution depolymerization material supply unit 381. In this case, at least a part of the first cooling unit 361 and the second cooling unit 362 in FIG. 6 may not be provided.

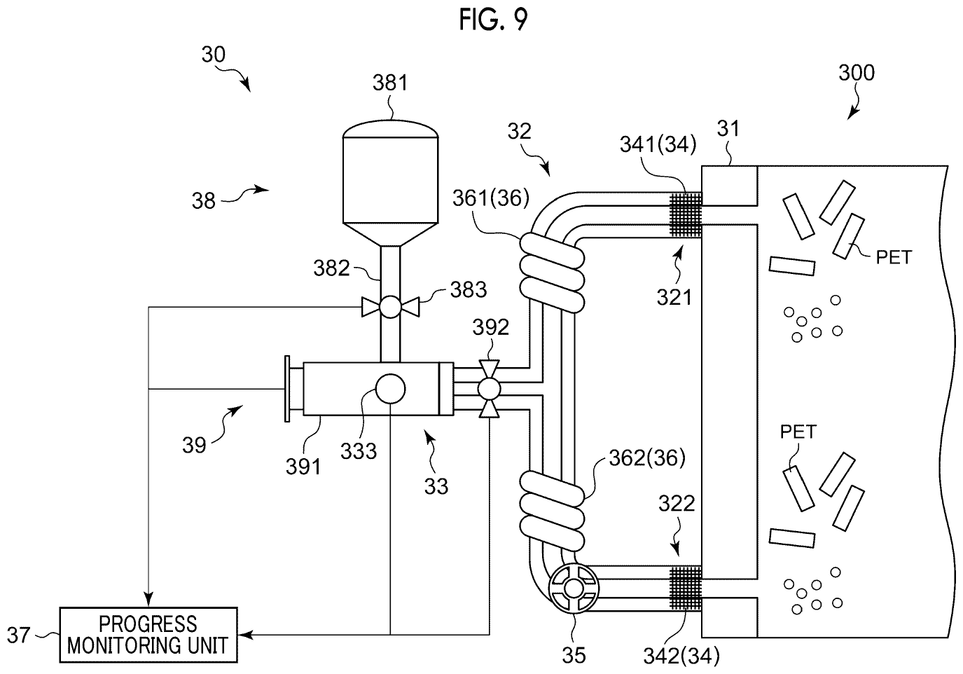

FIG. 9 shows still another embodiment of the depolymerization reaction monitoring device 30 according to the present invention. The same components as those in one embodiment in FIG. 4 and/or another embodiment in FIG. 6 are denoted by the same reference numerals, and overlapping description is omitted.

The depolymerization material flow portion 32 is provided with an extraction unit 39 that can extract a designated amount of the depolymerization material such as EG flowing inside the depolymerization material flow portion 32. The extraction unit 39 includes, for example, a syringe pump 391 and an extraction valve 392. The syringe pump 391 extracts or takes in, or discharges a depolymerization material such as EG in accordance with a position of a movable piston accommodated in the syringe pump 391. The extraction valve 392 is provided between the main body of the tubular depolymerization material flow portion 32 and the syringe pump 391. The extraction unit 39 may include another type of a pump instead of the syringe pump 391. For example, a gear pump, a suction pump, a plunger pump, or a vane pump may be provided in the extraction unit 39 instead of the syringe pump 391.

The characteristic measuring unit 33 is provided in the syringe pump 391. Specifically, as schematically shown in the drawings, the optical measurement as described above is performed through a window 333 provided in the syringe pump 391 (the light source 331 and the light receiving unit 332 are not shown). The characteristic measuring unit 33 measures the characteristic of the depolymerization material such as EG extracted by the extraction unit 39 (syringe pump 391).

As in another embodiment in FIG. 6, the depolymerization material flow portion 32 is provided with a depolymerization material dilution unit 38 that further adds a depolymerization material such as EG to the depolymerization material such as EG extracted by the extraction unit 39 (the syringe pump 391) to dilute the depolymerization material. The characteristic measuring unit 33 measures the characteristics of the depolymerization material such as EG diluted by the depolymerization material dilution unit 38.

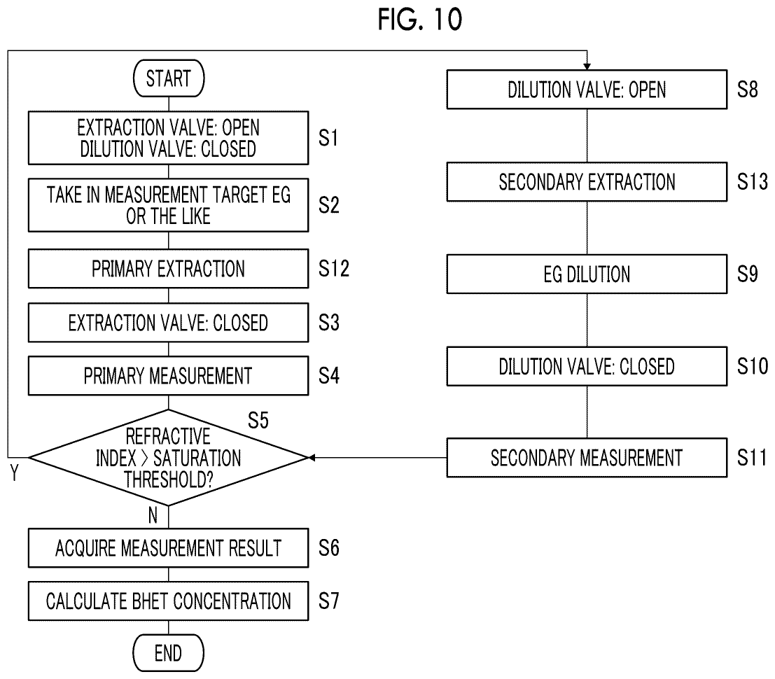

FIG. 10 is a flowchart of a specific example of a measurement procedure. The same steps or processes as those in FIG. 8 in another embodiment are denoted by the same reference numerals, and overlapping description is omitted.

In S1 at the start of the measurement, it is assumed that the extraction valve 392 is in an open state and the dilution valve 383 is in a closed state. In S2, a backwashing pump or the like constituting the direction switching unit 35 operates, and the depolymerization material such as EG, which is a measurement target, is taken from the tank main body 31 to the depolymerization material flow portion 32. In S12, the extraction unit 39 extracts the depolymerization material such as EG taken into the depolymerization material flow portion 32 in S2 by a designated amount (first designated amount) (primary extraction). In S3, the extraction valve 392 is switched to the closed state. As a result, the first designated amount of the depolymerization material such as EG is secured in the extraction unit 39 (the syringe pump 391).

In S4, the characteristic measuring unit 33 performs primary measurement of a refractive index of the first designated amount of the depolymerization material such as EG secured in the extraction unit 39 (the syringe pump 391) in S3. In S5, it is determined whether or not the refractive index measured in S4 exceeds a saturation threshold B shown in FIG. 7. In a case where “No” is determined in S5, the refractive index measured in S4 falls within a linear range equal to or less than the saturation threshold B and is therefore adopted as a measurement result by the characteristic measuring unit 33 in S6 as it is. In S7, the progress monitoring unit 37 calculates concentration of the depolymerized product such as BHET, based on the measurement result of the refractive index obtained in S6.

In a case where “Yes” is determined in S5, since the refractive index measured in S4 deviates from the linear range of the characteristic measuring unit 33, even though the process proceeds to S6 and S7, the correct concentration of the depolymerized product such BHET cannot be obtained. Therefore, in S8, the dilution valve 383 is switched to the open state. In S13, the extraction unit 39 extracts a designated amount (second designated amount) of EG for dilution or the like from the dilution depolymerization material supply unit 381 (secondary extraction) through the dilution valve 383 in the open state. Then, in S9, the EG or the like in the extraction unit 39 (the syringe pump 391) is diluted with the EG for dilution or the like extracted in S13. In S10, the dilution valve 383 is switched to the closed state. As a result, in addition to the first designated amount of the depolymerization material such as EG (in which the depolymerized product such as BHET is dissolved) primarily extracted in S12, the second designated amount of the depolymerization material such as EG (in which the depolymerized product such as BHET is not dissolved) secondarily extracted in S13 is secured within the extraction unit 39 (the syringe pump 391).

In S11, the characteristic measuring unit 33 performs the secondary measurement of the refractive index of the depolymerization material such as EG, which is secured within the extraction unit 39 (the syringe pump 391) in S3 and S10, with the first designated amount and the second designated amount, and the process returns to S5. In a case where “No” is determined in S5, the refractive index after dilution with EG measured in S11 falls within a linear range equal to or less than the saturation threshold B and is therefore adopted as a measurement result by the characteristic measuring unit 33 in S6 as it is. In S7, the progress monitoring unit 37 calculates the original (undiluted) concentration of BHET or the like in the tank main body 31 (the concentration on the straight line “after dilution” in FIG. 7) based on the secondary measurement result of the refractive index within the linear range obtained in S11, the first designated amount (obtained from the syringe pump 391 or the extraction valve 392) primarily extracted in S12, and the second designated amount (obtained from the syringe pump 391 or the dilution valve 383) secondarily extracted in S13. That is, as described above, the syringe pump 391, the extraction valve 392, and the dilution valve 383 can control the amount of the depolymerization material such as EG entering into the extraction unit 39 (the syringe pump 391) from the tank main body 31 (or the depolymerization material flow portion 32) and the dilution depolymerization material supply unit 381, respectively. Therefore, the progress monitoring unit 37 can calculate the concentration of BHET or the like in the tank main body 31 while identifying a quantitative effect of the dilution by the depolymerization material dilution unit 38.

In a case where “Yes” is determined in S5, the process proceeds to S8 to S11 again, and the secondary extraction in S13, the dilution in S9, and the secondary measurement in S11 are repeated until “No” is determined in S5, that is, until the secondary measurement result of the refractive index in S11 falls within the linear range of the saturation threshold B or less. In S7 at the end of the measurement, the extraction valve 392 and the dilution valve 383 are in the closed state.

The present invention has been described above based on the embodiment. Various modification examples are possible in the combination of each component and each process in the embodiment as an example, and it is obvious to those skilled in the art that such modification examples are included within the scope of the present invention.

The configurations, actions, and functions of each device and each method described in the embodiment can be realized by hardware resources or software resources, or by the cooperative operation of hardware resources and software resources. For example, a processor, a ROM, a RAM, and various integrated circuits can be used as the hardware resources. For example, programs such as an operating system and applications can be used as the software resources.

Certain embodiments of the present invention relate to a depolymerization reaction monitoring device and the like.

It should be understood that the invention is not limited to the above-described embodiment, but may be modified into various forms on the basis of the spirit of the invention. Additionally, the modifications are included in the scope of the invention.

What is claimed is:

1. A depolymerization reaction monitoring device comprising:
a depolymerization reaction tank that causes a depolymerization reaction in which a polyester is decomposed into a depolymerized product by using a depolymerization material;
a characteristic measuring unit that measures a characteristic of the depolymerization material in which the depolymerized product is dissolved at the depolymerization reaction tank; and
a progress monitoring unit that monitors progress of the depolymerization reaction based on the characteristic of the depolymerization material measured by the characteristic measuring unit.

2. The depolymerization reaction monitoring device according to claim 1,
wherein the depolymerization reaction tank includes a tank main body causing the depolymerization reaction and a depolymerization material flow portion through which the depolymerization material flows between the tank main body and the depolymerization material flow portion, and
the characteristic measuring unit measures the characteristic of the depolymerization material in the depolymerization material flow portion.

3. The depolymerization reaction monitoring device according to claim 2,
wherein one end and the other end of the depolymerization material flow portion are connected to different locations of the tank main body.

4. The depolymerization reaction monitoring device according to claim 3,
wherein an intrusion prevention unit that prevents insoluble matter that is not dissolved in the depolymerization material from intruding from the tank main body into the depolymerization material flow portion is provided on a side of the one end and a side of the other end of the depolymerization material flow portion.

5. The depolymerization reaction monitoring device according to claim 4, further comprising:
a direction switching unit that is configured to switch a flow direction of the depolymerization material in the depolymerization material flow portion between a first direction from the one end toward the other end and a second direction from the other end toward the one end.

6. The depolymerization reaction monitoring device according to claim 5,
wherein the direction switching unit includes a backwashing pump that is configured to switch the flow direction of the depolymerization material in the depolymerization material flow portion between the first direction and the second direction.

7. The depolymerization reaction monitoring device according to claim 2, further comprising:
a depolymerization material dilution unit that further adds the depolymerization material to the depolymerization material in the depolymerization material flow portion to dilute the depolymerization material.

8. The depolymerization reaction monitoring device according to claim 7,
wherein the depolymerization material dilution unit includes a dilution depolymerization material supply unit that supplies the depolymerization material, a dilution pipe that connects the dilution depolymerization material supply unit and the depolymerization material flow portion to each other, a dilution valve that is provided in the dilution pipe, a first valve that is provided on a side of one end of the depolymerization material flow portion with respect to a connection portion of the depolymerization material flow portion with the dilution pipe and the characteristic measuring unit, and a second valve that is provided on a side of the other end of the depolymerization material flow portion with respect to a connection portion of the depolymerization material flow portion with the dilution pipe and the characteristic measuring unit.

9. The depolymerization reaction monitoring device according to claim 2,
wherein the depolymerization material flow portion includes an extraction unit that is configured to extract a designated amount of the depolymerization material that flows, and
the characteristic measuring unit measures the characteristic of the depolymerization material extracted by the extraction unit.

10. The depolymerization reaction monitoring device according to claim 9,
wherein the extraction unit includes a syringe pump that extracts or takes in, or discharges the depolymerization material, and an extraction valve that is provided between a main body of the depolymerization material flow portion and the syringe pump.

11. The depolymerization reaction monitoring device according to claim 9, further comprising:
a depolymerization material dilution unit that further adds the depolymerization material to the depolymerization material extracted by the extraction unit to dilute the depolymerization material,
wherein the characteristic measuring unit measures the characteristic of the depolymerization material diluted by the depolymerization material dilution unit.

12. The depolymerization reaction monitoring device according to claim 2, further comprising:
a cooling unit that cools the depolymerization material in the depolymerization material flow portion.

13. The depolymerization reaction monitoring device according to claim 12,
wherein the cooling unit includes a first cooling unit on a side of one end of the depolymerization material flow portion with respect to the characteristic measuring unit and a second cooling unit on a side of the other end of the depolymerization material flow portion with respect to the characteristic measuring unit.

14. The depolymerization reaction monitoring device according to claim 1,
wherein the characteristic measuring unit measures an optical characteristic of the depolymerization material in which the depolymerized product is dissolved at the depolymerization reaction tank.

15. The depolymerization reaction monitoring device according to claim 14,
wherein the optical characteristic is a refractive index.

16. The depolymerization reaction monitoring device according to claim 1,
wherein the characteristic measuring unit measures an electrical characteristic of the depolymerization material in which the depolymerized product is dissolved at the depolymerization reaction tank.

17. The depolymerization reaction monitoring device according to claim 1,
wherein the polyester is polyethylene terephthalate,
the depolymerization material is ethylene glycol, and
the depolymerized product is bis (2-hydroxyethyl) terephthalate.

18. A depolymerization reaction monitoring method comprising:
causing a depolymerization reaction in which a polyester is decomposed into a depolymerized product by using a depolymerization material in a depolymerization reaction tank;
measuring a characteristic of the depolymerization material in which the depolymerized product is dissolved at the depolymerization reaction tank; and
monitoring progress of the depolymerization reaction based on the characteristic of the depolymerization material that is measured.

19. A non-transitory computer readable medium storing a depolymerization reaction monitoring program, the depolymerization reaction monitoring program when executed by a computer, causing the computer to:
cause a depolymerization reaction in which a polyester is decomposed into a depolymerized product by using a depolymerization material in a depolymerization reaction tank;
measure a characteristic of the depolymerization material in which the depolymerized product is dissolved at the depolymerization reaction tank; and
monitor progress of the depolymerization reaction based on the characteristic of the depolymerization material that is measured.
